(19) United States
(12) Patent Application Publication
(10) Pub. No.: US 2007/0058391 A1
(43) Pub. Date: Mar. 15, 2007

(54) Light extraction layer

(76) Inventors: Randall H. Wilson, Albuquerque, NM (US); Junwon Lee, Webster, NY (US)

Correspondence Address: Paul A. Leipold;Patent Legal Staff, Eastman Kodak Company, 343 State Street, Rochester, NY, 14650-2201, US

(21) Appl. No.: 11/226,141

(22) Filed: Sep. 14, 2005

(51) Int. Cl. F21V 7/04

(52) U.S. Cl. 362/606; 362/619; 362/620

(57) ABSTRACT

A light extraction layer and a display having a light extraction layer are described.

### CROSS-REFERENCE TO RELATED APPLICATIONS

The present invention is related to the following commonly assigned, pending application:

“Brightness Enhancement Film Using Light Concentrator Array” to Junwon Lee et al., U.S. Ser. No. 10/785,598, filed Feb. 24, 2004. The disclosure of this application is specifically incorporated herein by reference.

### FIELD OF THE INVENTION

The present invention generally relates to optical films, and more particularly relates to a light extraction film using an array of light extraction structures for conditioning illumination for use in display and lighting applications.

### BACKGROUND OF THE INVENTION

While liquid displays (LCDs) offer a compact, lightweight alternative to cathode ray tube (CRT) monitors, there are many applications for which LCD displays are not satisfactory due to a low level of brightness, or more properly, luminance. The transmissive LCD that is used in known laptop computer displays is a type of backlit display, having a light-providing surface positioned behind the LCD for directing light outwards, towards the LCD. The light-providing surface itself provides illumination that is essentially Lambertian, having an essentially constant luminance over a broad range of angles.

With the goal of increasing on-axis and near-axis luminance, a number of brightness enhancement films have been proposed for redirecting a portion of this light having Lambertian distribution toward normal, relative to the display surface. Among proposed solutions for brightness or luminance enhancement for use with LCD displays and with other types of backlit display types are the following:

U.S. Pat. No. 5,592,332 (Nishio et al.) discloses the use of two crossed lenticular lens surfaces for adjusting the angular range of light in an LCD display apparatus;

U.S. Pat. No. 5,611,611 (Ogino et al.) discloses a rear projection display using a combination of Fresnel and lenticular lens sheets for obtaining the desired light divergence and luminance;

U.S. Pat. No. 6,111,696 (Allen et al.) discloses a brightness enhancement film for a display or lighting fixture. With the optical film disclosed in the '696 patent, the surface facing the illumination source is smooth; the opposite surface has a series of structures, such as triangular prisms, for redirecting the illumination angle;

U.S. Pat. No. 5,629,784 (Abileah et al.) discloses various embodiments in which a prism sheet is employed for enhancing brightness, contrast ratio, and color uniformity of an LCD display of the reflective type. The brightness enhancement film is arranged with its structured surface facing the source of reflected light for providing improved luminance as well as reduced ambient light effects;

U.S. Pat. No. 6,752,505 (Parker et al.) discloses various types of surface structures used in light redirection films for LCD displays, including prisms and other structures;

U.S. Pat. No. 5,887,964 (Higuchi et al.) discloses a transparent prism sheet having extended prism structures along each surface for improved back-light propagation and luminance in an LCD display;

U.S. Pat. No. 6,356,391 (Gardiner et al.) discloses a pair of optical turning films for redirecting light in an LCD display, using an array of prisms, where the prisms can have different dimensions;

U.S. Pat. No. 6,280,063 (Fong et al.) discloses a brightness enhancement film with prism structures on one side of the film having blunted or rounded peaks;

U.S. Pat. No. 6,277,471 (Tang) discloses a brightness enhancement film having a plurality of generally triangular prism structures having curved facets;

U.S. Pat. No. 5,917,664 (O'Neill et al.) discloses a brightness enhancement film having “soft” cutoff angles in comparison with known film types, thereby mitigating the luminance change as viewing angle increases;

U.S. Pat. No. 5,839,823 (Hou et al.) discloses an illumination system with light recycling for a non-Lambertian source, using an array of microprisms; and,

U.S. Pat. No. 5,396,350 (Beeson et al.) discloses a backlight apparatus with light recycling features, employing an array of microprisms in contact with a light source for light redirection in illumination apparatus where heat may be a problem and where a relatively non-uniform light output is acceptable.

While known approaches, such as those noted in the disclosures mentioned above, provide some measure of brightness enhancement at low viewing angles, these approaches have certain shortcomings. Some of the solutions noted above are more effective for redistributing light over a preferred range of angles rather than for redirecting light toward the normal for best on-axis viewing. These brightness enhancement film solutions have a directional bias, working best for redirecting light in one direction. For example, a brightness enhancement film may redirect the light path in a width direction relative to the display surface, but have little or no effect on light in the orthogonal length direction. As a result, multiple orthogonally crossed sheets must be overlaid in order to redirect light in different directions, typically used for redirecting light in both horizontal and vertical directions with respect to the display surface. Necessarily, this type of approach is somewhat a compromise; such an approach is not optimal for light in directions diagonal to the two orthogonal axes. In addition, such known films typically use “recycling” in which the light is reflected back through the backlight module multiple times in an effort to increase brightness. However, some of the reflected light is absorbed by materials and lost in reflection during recycling.

As disclosed above, brightness enhancement layers have been proposed with various types of refractive surface structures formed atop a substrate material, including arrangements employing a plurality of protruding prism shapes, both as matrices of separate prism structures and as elongated prism structures, with the apex of prisms both facing toward and facing away from the light source. For the most part, these films exhibit directional bias, requiring the use of multiple sheets in practical applications.

Certain types of light redirecting layers rely on Total Internal Reflection (TIR) effects for redirecting light. These layers include prism, parabolic or aspheric structures, which re-direct light using TIR. Notably:

U.S. Pat. No. 5,396,350 to Beeson et al., cited earlier, discloses a backlight apparatus comprising a slab waveguide and an array of microprisms attached on one face of the slab waveguide.

U.S. Pat. No. 5,739,931 and No. 5,598,281 to Zimmerman et al. disclose illumination apparatus for backlighting, using arrays of microprisms and tapered optical structures;

U.S. Pat. No. 5,761,355 to Kuper et al. discloses arrays for use in area lighting applications, wherein guiding optical structures employ TIR to redirect light towards a preferred direction;

U.S. Pat. No. 6,129,439 to Hou et al. discloses an illumination apparatus in which microprisms utilize TIR for light redirection.

Japanese Laid-open Patent Publication No. 8-221013 discloses an illumination apparatus in which two light guide plates are joined with microstructures that utilize TIR;

U.S. Pat. No. 6,425,675 to Onishi et al. discloses an illumination apparatus in which a light output plate has multiple projections having respective tips held in tight contact with the light exit surface of the light guide member and a bonding process to improve bonding power and avoid embedment of projections.

As can be appreciated from the above description, known light redirecting layers for optical displays have largely been directed to improving brightness of a display over a range of angles. However, the uniformity of the light spatially over the display surface is important to ensure uniform image brightness. Unfortunately, while known light redirecting layers may provide improved luminance, such layers may have bright and dark regions due to poor light uniformity across the display surface. To this end, existing light redirecting layers, in an effort to achieve higher brightness, often compromise display uniformity, creating bright spots and other anomalies in the light output to the LC panel or other light valve.

In addition to improving the spatial uniformity of light in a display, light redirecting layers should also not create appreciable interference effects such as Moiré effects. As is known, the spacing or pitch of the brightness enhancement film may be nearly commensurate with elements of the LC panel. This can result in Moiré fringes in the image, which are undesirable.

What is needed, therefore, is a light redirecting layer that overcomes at least the shortcomings of known films previously described.

### SUMMARY OF THE INVENTION

As used herein, the terms ‘a’ or ‘an’ means one or more, and the term ‘plurality’ means at least two.

In accordance with an example embodiment, a light extraction layer includes a first end portion and a central portion. The light extraction layer also includes a first side and a second side, and a plurality of light extraction features disposed over the first side. At least two of the light extraction features have different lengths and an optical contact ratio is greater at the central portion than at the first end portion or the second end portion.

In accordance with another example embodiment, a display device includes a light guide having a first end, a second end, a top surface and a bottom surface. The display device also includes at least one light source coupled to the first end or the second end, or both, and a light extraction layer disposed over the top surface. The light extraction layer includes a first end portion, a second end portion and a central portion and a first side and a second side. The light extraction layer also includes a plurality of light extraction features disposed at least the top surface. At least two of the light extraction features have different lengths and an optical contact ratio between the light extraction layer and the light guide is greater at the central portion than at the first end portion or the second end portion.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion. Wherever practical, like reference numerals refer to like elements.

FIG. 1A is a cross-sectional view of a LEX layer disposed over a light guide in accordance with an example embodiment.

FIG. 1B is a perspective view of a LEX layer disposed over a light guide in accordance with an example embodiment.

FIG. 1C is a perspective view of a LEX layer disposed over a light guide in accordance with an example embodiment.

FIG. 1D is a perspective view of a LEX layer disposed over a light guide in accordance with an example embodiment.

FIG. 1E is a perspective view of a LEX layer disposed over a light guide with a single light source in accordance with an example embodiment.

FIG. 1F is a perspective view of a LEX layer in accordance with an example embodiment.

FIG. 2 is a perspective view of a LEX layer in accordance with an example embodiment.

FIG. 3 is a partial cross-sectional view of a LEX layer with constant pitch and varying feature width in accordance with an example embodiment.

FIG. 4 is a top view of a LEX layer having optical contact ratio varying across the LEX layer in accordance with an example embodiment.

FIG. 5 is a top view of a LEX layer where the optical contact ratio varies across the LEX layer in accordance with another example embodiment.

FIG. 6 is a cross-sectional view of a LEX layer being replicated from a mold in accordance with an example embodiment.

FIGS. 7A and 7B are cross-sectional views of a LEX layer as it might be fabricated from a mold created with an example fabrication process in accordance with an example embodiment.

FIG. 8 is cross-sectional view of a diamond cutter fabricating a LEX mold in multiple cuts in accordance with an example embodiment.

FIGS. 9A and 9B are cross-sectional views of a diamond cutter fabricating a LEX mold with varying cavity widths in accordance with an example embodiment.

FIGS. 10A and 10B are cross-sectional views of a diamond cutter that might be used to fabricate a LEX mold in accordance with an example embodiment.

FIG. 11 is a perspective view of a cutter cutting example features in a LEX mold in accordance with an example embodiment.

FIG. 12A is a graphical representation of the feature index from an edge of a LEX layer versus feature length of a LEX layer in accordance with an example embodiment.

FIG. 12B is a graphical representation of luminance versus distance from a CCFL in accordance with an example embodiment.

FIG. 13A is a cross-sectional view of light extraction features and light trajectories from the features of a LEX layer according to example embodiments.

FIG. 13B is a cross-sectional view of a light extraction feature including a base structure and a light extraction feature without a base structure.

FIG. 14 is a graphical representation of a cross-section of a parabolic-shaped light extractor in accordance with an example embodiment.

FIG. 15 is a graphical representation of a cross-section of an aspheric-shaped light extractor in accordance with an example embodiment.

FIG. 16 is a graphical representation of viewing angle versus luminance of a LEX layer of an example embodiment and a known brightness enhancement film (BEF) layer.

FIG. 17 is a graphical representation of viewing angle versus luminance of a LEX layer of an example embodiment at a center of a display and at an edge of a display.

FIG. 18 is a graphical representation of viewing angle versus measured luminance of a LEX layer in accordance with an example embodiment compared to the measured luminance of a known BEF layer.

FIG. 19 is a graphical representation of viewing angle versus luminance of a LEX layer of an example embodiment.

FIG. 20 is a graphical representation of viewing angle versus luminance of a LEX layer of an example embodiment.

FIG. 21 is a perspective view of a display device in accordance with an example embodiment.

### DETAILED DESCRIPTION OF THE INVENTION

In the following detailed description, for purposes of explanation and not limitation, example embodiments disclosing specific details are set forth in order to provide a thorough understanding of the present teachings. However, it will be apparent to one having ordinary skill in the art having had the benefit of the present disclosure that other embodiments that depart from the specific details disclosed herein. Moreover, descriptions of well-known devices, methods and materials may be omitted so as to not obscure the description of the example embodiments. Nonetheless, such devices, methods and materials that are within the purview of one of ordinary skill in the art may be used in accordance with the example embodiments.

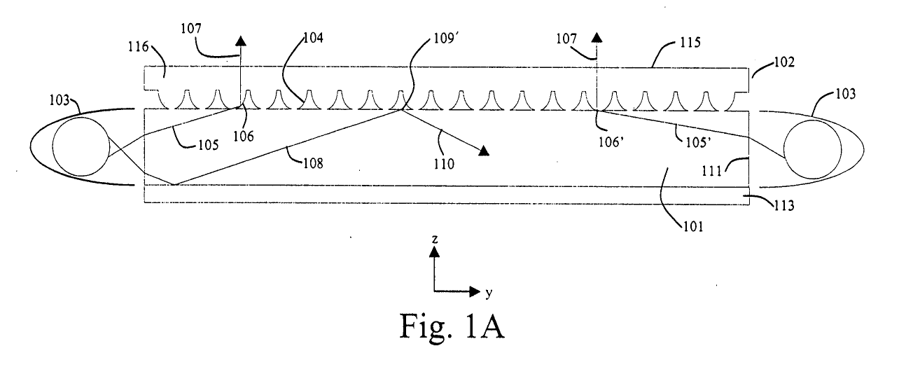

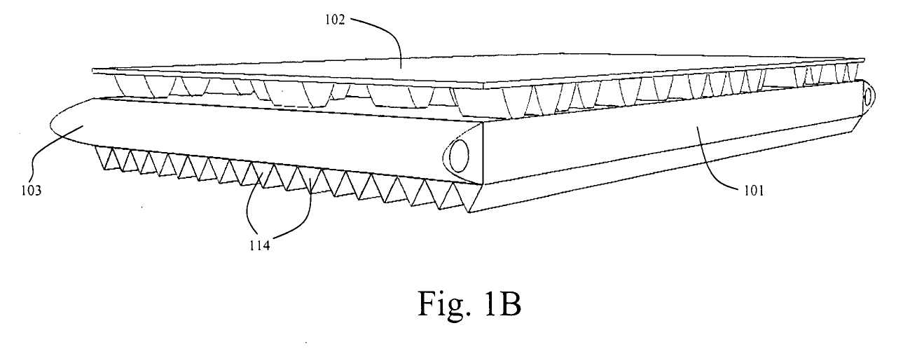

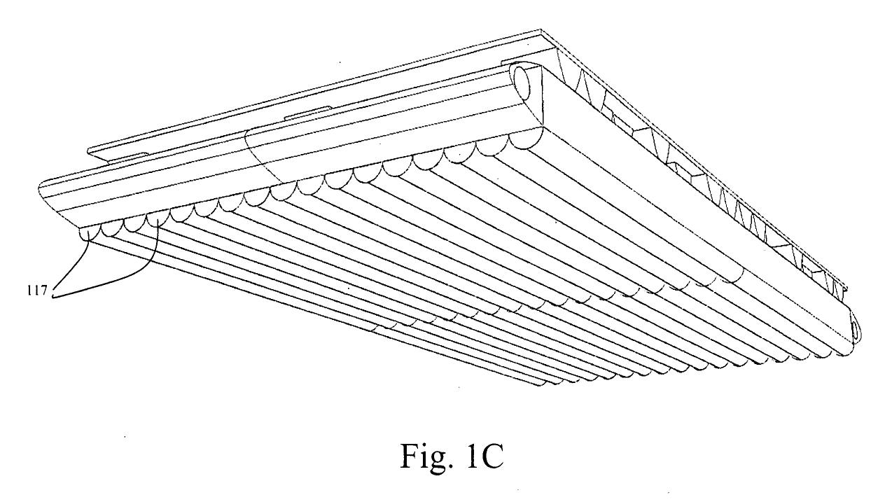

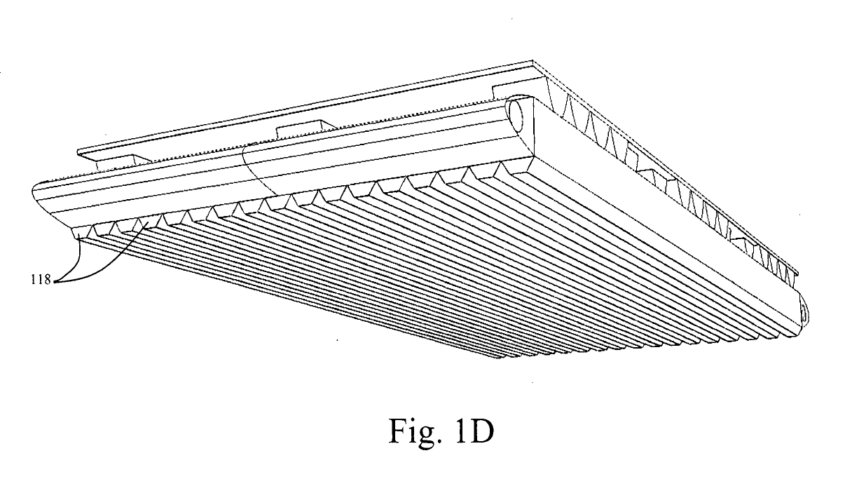

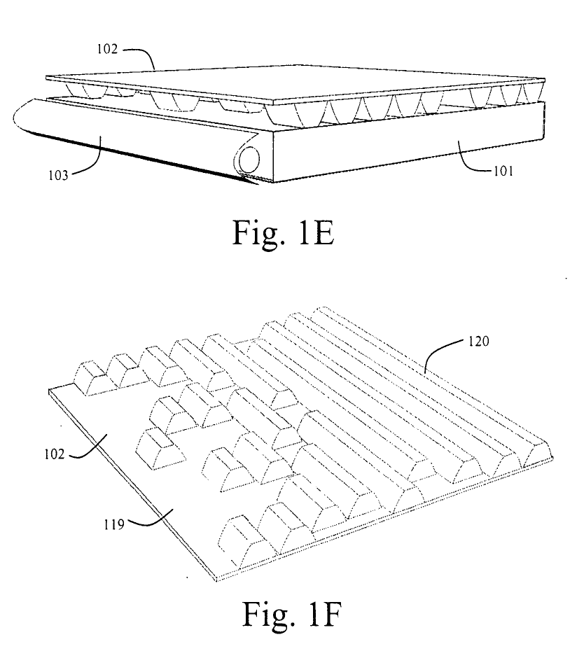

FIG. 1A is a cross-sectional view of a light extraction layer (LEX) 102 disposed over a light guide 101 in accordance with an example embodiment. In the present embodiment, light sources 103 are disposed on each end of the light guide. In other embodiments, only one light source is used. The light sources 103 may be cold cathode fluorescent lights (CCFLs), which are used in lighting and display applications. It is emphasized that the use of CCFLs is merely illustrative and that other light sources including, but not limited to light emitting diodes

(LEDs) may be used as the light sources 103. The combination of the light guide 101, the LEX 102 and the light sources 103 has application in lighting and display applications. In either application, the combination may be used to provide brighter (greater luminance) and more uniform lighting. As to the latter, the combination may be implemented in transmissive LCD applications. In both lighting and display applications other elements are required. These elements are known to one of ordinary skill in the light and display arts and are neither shown nor described so as to avoid obscuring the description of the example embodiments.

The LEX 102 includes a plurality of light extraction features (‘features’) 104 disposed over a top surface of the light guide. Light 105, 105′ from the light sources 103 is incident on the lower portion of the feature 104 and is reflected from a surface 106, 106′ of the feature 104 and transmitted as light 107. In a specific embodiment, light 107 is transmitted substantially orthogonal to a surface 115 of an integral substrate 116 of the layer 102. In another specific embodiment, the light reflected from the surface 106 is not perpendicular to the surface 115. Details of the control of the angle of light reflected from surface 106 are provided herein.

As appreciated by those of ordinary skill in the art, the light guide 101 and the LEX 102 beneficially have indices of refraction (nᵣ) that are substantially identical in order to improve the extraction of light by the features 104 and to substantially prevent light 105 being reflected back into the light guide 101. Providing substantially the same indices of refraction may be achieved by forming the light guide 101 from the same material, or by choosing different materials with substantially the same indices of refraction.

In a specific embodiment, the substrate 116 and the features 104 are integral, with the features 104 being formed from the substrate 1116. In another specific embodiment, the features 104 are not integral with the substrate 104, and are adhered to the substrate 116. In either case, the material of the substrate 116 and the features 104 are beneficially of the same material or of different materials having substantially the same indices of refraction (nᵣ).

In general, LEX 102 may be of a variety of materials. In a specific embodiment, LEX 102 is formed from an acrylic film; however, LEX 102 may be formed from any of various types of transparent materials, including, but not limited to polycarbonate, polyethylene terephthalate (PET), polyethylene naphthalate (PEN), or polymethyl methacrylate (PMMA).

As described in further detail herein, light incident on the features 104 is substantially totally internally reflected and transmitted to the display component or lighting components. As is known, there is an insignificant amount of light energy lost in total internal reflection (TIR). In reality, losses are due mainly to absorption of light by the material. However, this is an insignificant fraction of the light incident on the features 104. Thus, little light energy is lost. Moreover, the index matching further reduces light energy loss. As such, displays and lighting devices that incorporate the LEX 102 will be exceedingly efficient due to low light loss. This provides an improved luminance level compared to known BEF layers that rely on multiple reflections between prism structures and a bottom reflector to enhance mainly near on-axis brightness. Since the bottom reflector absorbs some of the light energy at each incidence and light is incident on the bottom reflector multiple times before emerging from the BEF layers, a significant amount of light energy is lost to absorption.

Light 108 is incident on a point 109 of a surface of the light guide 101 and is reflected as light 110 back into the light guide 101. As is known, the light guide 101 is a waveguide that traps the light therein. As such, the light is totally internally reflected from each surface of the light guide. At least some of the light reflected within the waveguide is incident at a portion of the top surface of the waveguide over which the LEX 102 is disposed. Thus, after traveling within the light guide 101 a significant portion of the light from the light sources 103 is transmitted as light 107 to the display or lighting elements.

In order to control beam divergence in the direction normal to the plane of FIG. 1, a bottom micro-structured layer 113 may be used. In a specific embodiment described herein, the bottom micro-structured layer 113 includes a plurality of prism-shaped elements that reduce beam angle by total internal reflection (TIR) in a direction normal to the plane of FIG. 1A and thus more efficiently enhance near on-axis brightness. Depending on the viewing angle requirement, the apex angle of the prismatic structure is in the range of approximately 20.0 degrees to approximately 170 degrees. Illustratively, the pitch of the prismatic structure is in the range of approximately 10.0 micrometers to approximately 1.0 millimeter. In specific embodiments, the pitch is in the range of approximately 25.0 micrometers to approximately 200 micrometers.

Notably, the bottom micro-structured layer 113 may include features that are other than prism-shaped. For example, the micro-structured layer may have features that are arc, semi-circular, conic, aspherical, trapezoidal, or composite of at least two shapes in cross-section. The pitch of each shape is in the range of approximately 10.0 micrometers to approximately 1.0 millimeter; and in specific embodiments the pitch is in the range of approximately 25.0 micrometers to approximately 200.0 micrometers.

In general, the features of the micro-structured layer 113 are generally elongated in shape in a direction perpendicular to light input surface 111 on light guide 101. The size and shape of features can be varied along this direction. For example, the apex angle of a prismatic shape may be approximately 90.0 degrees near the light input surface 111 and approximately 140.0 degrees farther away from the light source (i.e. toward the central portion of the light guide). The features of the micro-structured layer 113 can be continuous or discrete, and they can be randomly disposed, staggered, or overlapped with each other. Finally, a bottom reflector that is planar or has a patterned relief may be disposed beneath the light guide 101 or micro-structured layer 113 in order to further enhance brightness by reflecting back to the display light that has been reflected or recycled from display or backlight structures.

As detailed herein, the features 104 of the LEX 102 are disposed to provide an increased luminance to display and lighting surfaces. Moreover, the light provided to the display and lighting surfaces is more uniformly distributed over the surfaces. The combined effect is an increased luminance and a greater uniformity of light in display and lighting application. In addition, the ill-effects of interference patterns such as Moiré patterns are substantially mitigated through the structures of the example embodiments.

FIG. 1B is a perspective view of the LEX 102 in accordance with an example embodiment. The LEX 102 includes the light extraction features 104 described previously. In addition, the LEX 102 includes the micro-structured layer 113 having features 114, which in this embodiment are prism-shaped.

FIG. 1C is a perspective view of the LEX 102 in accordance with an example embodiment. The LEX 102 includes the light extraction features 104 described previously. In addition, the LEX 102 includes the micro-structured layer 113 having features 117, which in this embodiment are semi-circular in cross-section.

FIG. 1D is a perspective view of the LEX 102 in accordance with an example embodiment. The LEX 102 includes the light extraction features 104 described previously. In addition, the LEX 102 includes the micro-structured layer 113 having features 118, which in this embodiment are trapezoidal in shape.

FIG. 1E is a perspective view of a LEX 102 in accordance with an example embodiment. In this embodiment the LEX 102 is used with a single light source 103 at one end of a light guide 101. The light guide 101 may be planar as shown, or may be wedge-shaped as known in the art.

FIG. 1F is a perspective view of the LEX 102 shown in FIG. 1E. Notably, the features in the region 119 that will be disposed near the light source are shorter and farther apart than the features in the region 120 that will be disposed at the side without a light source.

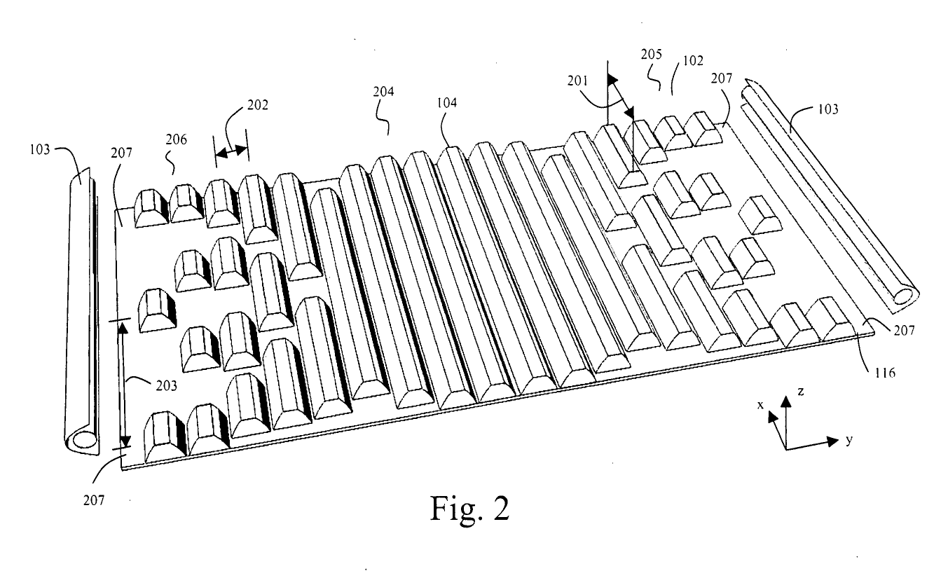

FIG. 2 is a perspective view of the LEX 102 in accordance with an illustrative embodiment. The features 104 each have a length, 201, a first pitch, 202 and a second pitch, 203. Consistent with the coordinate axes of FIG. 2, the length 201 is along the x-axis, the first pitch 202 is along the y-axis and the second pitch 203 is along the x-axis. Notably, the z-axis is directed toward the viewer of the display (not shown). Each feature has a cross-sectional shape in the yz-plane and the cross-sectional shape is substantially constant along the length of the feature. In specific embodiments, the features 104 on the LEX have substantially the same cross-sectional shape. Furthermore, the LEX 102 has a central portion 204, a first end 205 and a second end 206.

In light and display applications where light sources 103 are at the ends of the light guide layer (e.g., as shown in FIG. 1), the LEX 102 usefully improves the luminance to the display/lighting surface and the uniformity of the light provided as well. To this end, the light intensity at the regions of the light guide 101 nearest to the light sources 103 is greatest due to the proximity to the light sources. Known light-extracting layers do not suitably account for this and extract light across the surface of the light guide 101 as though the light were equally intense across the light guide. Thus, in many display and lighting applications, the amount of light extracted at the regions near the light sources is greater than, for example, in the center of the light guide. As can be readily appreciated, this can result in variations in brightness across the display or lighting surface.

In the present example embodiment, the length 201 of the features 104 is selected to provide a suitable amount of optical contact area with the light guide 101 relative to the location on the LEX 102. The optical contact area in a region of a LEX 102 is the area of the contact between the LEX 102 and the light guide 101 in the region. The optical contact ratio in a region of a LEX 102 is the ratio of the optical contact area in the region to the total area of the light guide surface in the region. For example, in the first and second portions 205, 206 near the light sources 103, the length of the elements is relatively small. Thus, the optical contact area per unit area of the LEX 102 is less in the first and second portions 205, 206. This translates directly into a smaller optical contact ratio of features 104 with the light guide 101. The lower the optical contact ratio between the features 104 and the light guide 101 in a certain area, the lower the amount of light (flux) that will be extracted from the light guide in this area.

By contrast in a central portion 204 of the LEX 102, the length 201 of the features is relatively large. Thus, the optical contact of the features 104 per unit area is greater in the central portion 204. This translates directly into a greater optical contact ratio of the features 104 with the light guide 101. The greater the optical contact ratio between the features 104 and the light guide 101, the greater the amount (flux) of light extracted from the light guide in a particular area.

In accordance with example embodiments, light from the light sources 103, which is normally most intense in the first and second portions 205, 206, is purposely extracted to a lesser extent in these portions; and light in the central portion 204, which is normally less intense compared to the first and second portions 205, 206 is purposely extracted to a greater extent in this portion. Overall, this fosters a more uniform extracted light distribution compared to known light-extracting structures.

As will be apparent to those skilled in the art, this approach may also be applied to achieve desired non-uniform light distributions. In this case, the optical contact area is increased further in regions where the brightness is desired to be higher than the average across the display, and the optical contact area is decreased further in regions where the brightness is desired to be lower than average.

The LEX 102 provides a greater uniformity of light distribution by selecting the optical contact area to be greater where there is less light and smaller where there is more light (greater flux). This principle can be used to increase the local uniformity of light in certain regions of the LEX 102. For instance, in many display applications, there can be dark regions in the corners of the display. In this case, the light flux in the light guide varies in the x-direction, parallel to the light source. As such, for one reason or another, even though the corners translate to portions of the light guide 101 near the light sources 103, there can be less light extracted from the light guide at these portions. In keeping with the example embodiments, the intensity of the light at the corners may be increased and the local uniformity of the light distribution improved by increasing the optical contact of features in the corners 207 of the LEX 102. Similarly, if a region of a display or lighting device has a local brightness, the local uniformity can be improved by reducing the optical contact area at the corresponding portion of the LEX 102. In the former case, the features may be made longer and in the latter the features may be made shorter in order to increase and decrease, respectively, the optical contact area in the pertinent portion of the LEX 102.

In general, the light flux in the light guide 101 will require a given amount of optical contact area at each location on the LEX, where the optical contact area is calculated over a comparatively small ‘neighborhood’ of the LEX around each location. The neighborhood must be small enough to avoid visible non-uniformity of brightness to the viewer of the display. The neighborhood must also be small enough to support variation in brightness across the LEX without brightness transitions between neighborhoods that are visible to the viewer of the display. As a result, the size of the neighborhood will depend on the application, and depends on pixel size of the LCD display, diffusing power of layers to be placed between the LEX and the LC panel, expected distance from the display to the viewer, and other application-specific factors. The size of a neighborhood might be considerably less than the size of a small LC panel pixel or might be as large as approximately 1.0 millimeter or more in larger display applications.

In example embodiments, the first pitch 202 is substantially the same across the LEX 102. The first pitch 202 is illustratively between approximately 10.0 micrometers and approximately 300.0 micrometers depending on the type of display and is chosen in order to mitigate the ill-effects of interference patterns such as Moiré interference in lighting and display applications. Moiré patterns become visible when two periodic or partially-periodic patterns are superimposed on each other. The period of Moiré patterns is calculated as follows:

$${p}_{M} = {( \vert \frac{n}{{p}_{1}} - \frac{m}{{p}_{2}} \vert )}^{- 1} \qquad ( 1 )$$

where p₁ and p₂ are pitches of two periodic patterns and p_{M} is the period of the resulting Moiré pattern when the two patterns are superimposed. The n and m are positive integer numbers. Generally speaking, Moiré patterns are not visible for cases when n or m is greater than or equal to 4. This means that a human eye usually cannot perceive Moiré patterns if one of the two pitches becomes smaller than one fourth of the other pitch. Depending on other details of the two periodic patterns, in many cases when one pitch p₁ is known, another pitch p₂ can be chosen such that substantially all of the resulting Moiré patterns are of sufficiently low contrast, or sufficiently high or low frequency, that they are not visible to the human eye or they can be hidden using a diffusing sheet or other means added to the display.

Known light extracting layers include a varying y-direction pitch along the y-direction of the layer, using the coordinate system of FIG. 2. Varying the pitch provides variance in the optical contact ratio. However, the varying pitch in these known structures can cause objectionable Moiré patterns in the display. As these fringes degrade the image quality of the display or the light pattern of a lighting device, they are beneficially avoided or mitigated to the extent possible. Furthermore, varying the pitch in the y-direction can only compensate for y-direction variability in the light flux in the light guide, and cannot compensate for x-direction variability in the light flux in the light guide.

In order to prevent or at least significantly reduce Moiré fringes, in example embodiments the first pitch 202 is selected and maintained substantially constant across the LEX 102. This may be done by choosing the pitch 202 smaller than approximately 0.25 times the pitch of LC panel in the corresponding direction or by choosing pitch 202 in other ways such that all interference patterns are not visible to the human eye.

In other example embodiments, the first pitch 202 may be variable across the LEX 102 in order to substantially avoid objectionable Moiré patterns. For example, the positions of the features 104 in the y-direction may be randomly perturbed in the y-direction while maintaining the desired optical contact density within each small neighborhood on the LEX 102. (As used herein, the term “random” means random or pseudo-random as generated by computer algorithms or other methods known in the art.)

The second pitch 203 along the x-direction is also selected to significantly reduce, if not prevent Moiré effects. The second pitch 203 is chosen with respect to the pitch of periodic structures in the LC panel or other display components in the corresponding x-direction.

In a specific embodiment, the second pitch 203 is substantially constant and is selected in a manner described in connection with the selection of the first pitch 202. In such embodiments, the length of the features 104 may be varied to achieve the desired optical contact area in each neighborhood. If it is not feasible to fabricate the features 104 small enough to achieve the desired optical contact area in any neighborhood, then some of the features 104 may be omitted entirely. The features 104 that are omitted may be in a carefully-chosen pattern (such as every other one, every third one, or in a ‘checkerboard’ pattern), or they may be omitted in a randomly chosen pattern, so long as the optical contact area in each small neighborhood is preserved. Methods known in the art may be used to determine the length of features and which features are omitted. These methods include dithering techniques such as half-toning, Floyd-Steinberg dithering, and partially-random dithering methods.

In another example embodiment, the lengths of the features 104 may be constant and the second pitch 203 varied to achieve the desired optical contact area. In this case, the x positions, and resulting pitches, of the features may be randomly perturbed to lessen Moiré effects.

In other example embodiments, the length of features 104 and the second pitch 203 are both varied while maintaining the desired optical contact ratio within each neighborhood. For purposes of illustration, consider the area of the LEX 102 divided into rows. Further suppose the desired optical contact ratio in a neighborhood requires that 60% of a row in the x-direction consist of features 104, with 40% ‘empty’ space between features. This could be achieved by features 104 that are 60 micrometers long and spaces that are 40 micrometers long (i.e., second pitch 203 of 100 micrometers), or features 104 that are 90 micrometers long and spaces that are 60 micrometers long (for a second pitch 203 of 150 micrometers), or any other combination that maintains the approximately 60:40 ratio between feature lengths and spaces. A row may have features 104 and spaces therebetween of several sizes, where the average over the neighborhood achieves substantially the desired optical contact ratio. The feature positions, lengths, and spaces may follow a pattern designed to minimize Moiré interference effects; or may be chosen randomly from a range of possible values such that the desired optical contact ratio is achieved.

In still other example embodiments, first pitch 202 and second pitch 203 may both be varied across the LEX in ways that avoid or minimize Moiré effects. One example of placing features 104 in these embodiments, as will be appreciated by one skilled in the art, is analogous to the placement of backlight dots as described in Journal of the Optical Society of America A, Vol. 20, No. 2, February 2003, pp. 248-255, to Ide, et al., the disclosure of which is specifically incorporated herein by reference. With this method, the locations of features 104 are determined by combinations of known methods such as random placement, low-discrepancy sequences, and dynamic relaxation. Additional similar methods will be appreciated by those skilled in the art. As applied to the present embodiment, such methods result in non-periodic yet varying-pitch patterns that achieve the desired optical contact ratio within each small neighborhood of the LEX 102 and simultaneously avoid or minimize Moiré patterns.

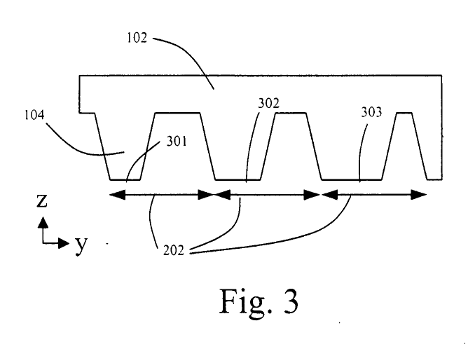

An alternative method to vary the optical contact area in different regions of the LEX 102 involves varying the width of the contact area of each feature 104 measured in the y-direction of FIG. 2. By increasing the width of the optical contact between the LEX 102 and the light guide, the effective aperture of each feature 104 is increased and more light is extracted. Similarly, by decreasing the width of the optical contact, the aperture is reduced and less light is extracted. FIG. 3 is a cross-sectional view of features 104 that illustrates the variation of the width of the contact area of the features 104 of a LEX 102. Notably, in the present example embodiment, the features 104 are shown with straight sides but they may have other shapes as well. The first pitch 202 from feature to feature in the y-direction may be substantially constant as shown, or may vary according to other specific embodiments. The optical contact width 301 of one feature 104 is smaller than the optical contact width 302 of another feature 104, which in turn is smaller than the optical contact width 303 of yet another feature.

As described below, straightforward methods may be used to fabricate such features. One factor to be considered when varying the width of the contact area as illustrated in FIG. 3 is that widening the contact area may also change the resulting angular light distribution, resulting in a different distribution at different locations on the LEX 102. This may be acceptable or desirable, particularly when used in combination with the other methods described herein.

The methods used to place features, the choices of first and second pitches, and the methods of varying the optical contact area described above may be combined in embodiments. The method chosen will depend on the particular application domain and details.

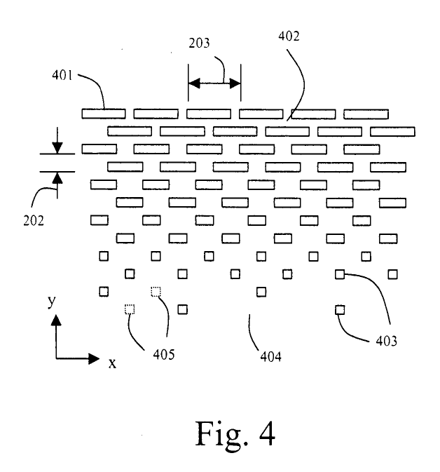

FIG. 4 illustrates the optical contact area of the features 104 of a LEX 102 in accordance with an example embodiment. In the present embodiment, the first pitch 202 in the y-direction and the second pitch 203 in the x-direction are both constant across the LEX 102. The lengths of the features 401 are increased in the upper region 402 to increase optical contact area, and the lengths of features 403 are decreased in the lower region 404 to decrease optical contact area. At the lower region 404, some features (shown as dotted line features 405) have been omitted entirely to further decrease optical contact area in that region.

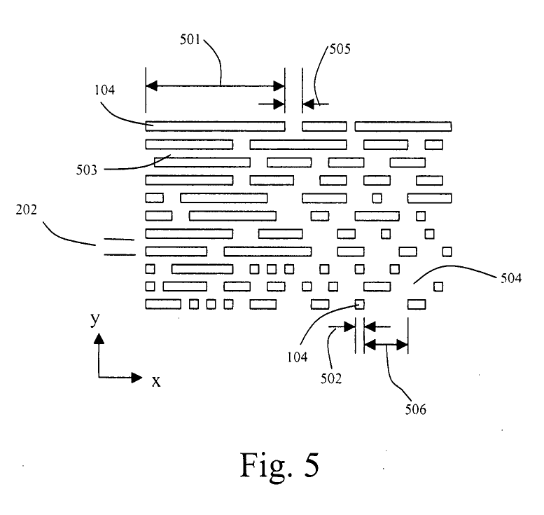

FIG. 5 illustrates another example embodiment. In this embodiment the first pitch 202 in the y-direction is chosen to be constant and less than approximately one-fourth of the LC panel pixel pitch in the corresponding direction to avoid Moiré, while the second pitch 203 in the x-direction is varied randomly together with the feature length 501, 502 to achieve the desired optical contact area in each neighborhood of the LEX 102. The optical contact area is greater in region 503 of the illustrated area of the LEX 102, and the optical contact area is comparatively smaller in region 504. Notably, the optical contact ratio in this example embodiment varies in both the x-direction and the y-direction. In the region 503, the feature lengths 501 are generally greater and the spaces 505 between features are generally smaller. In the region 504, the feature lengths 502 are generally smaller and the spaces 506 between features are generally larger.

Notably, the optical contact area can be tailored to extract light from the light guide 101 by forming the features 104 as discrete or discontinuous elements, having a substantially constant pitch (in the y-direction of FIGS. 2 and 5) that is selected to avoid creating a visible Moiré pattern. Moreover, as described previously, the features 104 are formed so as to avoid Moiré patterns in the direction of their length (x-direction).

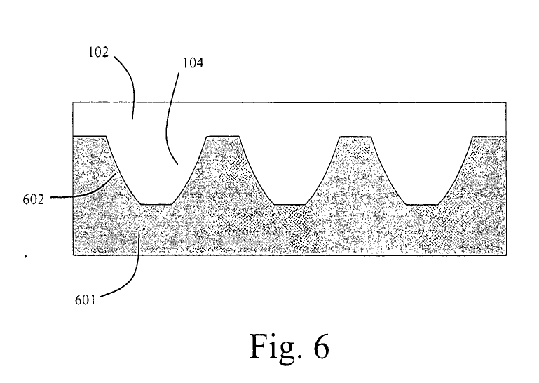

A LEX according to the example embodiments may be fabricated using a variety of known methods, generally involving replication from a mold. FIG. 6 shows a cross-section of a LEX 102 being replicated from a mold 601. The mold 601 may be made of materials such as copper, aluminum, nickel and other standard mold materials and alloys thereof. The mold material must be capable of holding optical-quality surfaces and of withstanding the stresses induced by the intended molding processes. Mold cavities 602 (‘cavities’) in the mold are the negative shape of the features 104 being formed in the LEX.

In one embodiment, the mold may be planar and the LEX is formed by injection molding. In another embodiment, the LEX is formed as a film in a roll-to-roll process using a mold in roller form. Suitable forming processes will be known to those skilled in the art, including but not limited to solvent or heat embossing, UV casting, or extrusion-roll molding as disclosed in U.S. Pat. No. 6,583,936, the disclosure of which is specifically incorporated herein by reference. After the continuous film is formed in a roll-to-roll process, then the individual LEX pieces may be cut from the film. If the optical contact ratio of the LEX only varies along the y-direction, then the roller for the LEX may be made with one or more continuous bands around the roller, and the individual LEX pieces may be cut from film that is molded from any circumferential position around the roller. However, if the optical contact ratio of the LEX varies along the x-direction as well, for example to compensate for dark corners in the light guide, then the roller will have one or more rectangular images of the LEX on it, and the individual LEX pieces must be cut from the corresponding locations on the film. The roller might have images of one or more different LEX designs for multiple applications.

A roller for molding LEX may be fabricated using a gravure-type engraving process, or by a digitally controlled fast-servo diamond turning machine, or similar technology. For example, gravure-type engraving may be effected in accordance with commonly assigned U.S. patent application Ser. No. 10/859,652 entitled “Method for Making Tools for Microreplication” to Thomas Wright, et al. The disclosure of this application is specifically incorporated herein by reference. In these processes, a blank roller is mounted in a cutting machine, and the roller is turned about its axis. A cutting head moves a cutter into and out of the surface of the roller as the roller turns. The cutting edges of the cutter determine the cross section of the mold cavity.

In the coordinate system of FIG. 2, the turning of the roller creates the lengthwise (x) direction of the cavities. The timing of moving the cutter into the surface determines the x starting position of each cavity, and the length of time the cutter is left in the roller determines the length of that cavity. After cutting cavities at a particular axial position on the roller (corresponding to the y-direction location of the features), the cutting head is moved to a new axial position to cut additional cavities. By repeating this process across the roller, a roller may be fabricated to produce LEX in a roll-to-roll replication process.

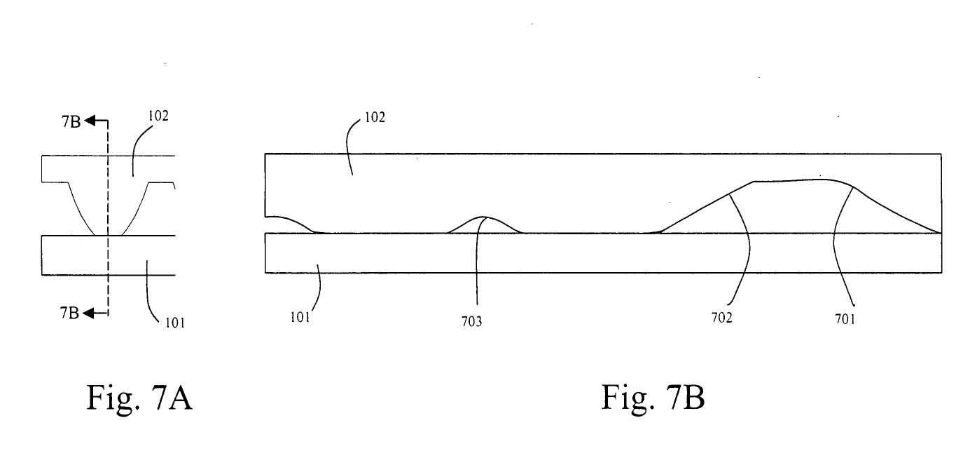

FIG. 7A illustrates a cross-section of a single LEX feature 104 and the light guide 101 it contacts. FIG. 7B shows a cross-section of the same feature 104 along the xz-plane of the LEX 102. In creating a roller or mold 601 for a LEX, the cutter typically cannot enter or exit the roller surface instantly. As the roller turns, the cutter enters the roller surface, resulting in a sloped end 701 on the roller cavity 602 and on the feature 104 as well. Typical cavity and feature end slopes range from approximately 5 degrees to approximately 25 degrees measured from the uncut roller surface. The cutter may be able to exit the roller surface more quickly than it enters, or vice versa, resulting in different slopes on two sloped ends 701, 702 of the LEX features 104. In some cases, when the features are spaced closely in the x-direction, the cutter may not fully exit from the roller surface before starting to plunge again for the next cavity, as shown at point 703. This is acceptable for a LEX because the features do not need to be fully interrupted, but only need to become small enough that they no longer contact or are laminated to the light guide, thus avoiding optical contact and keeping light from being extracted (e.g., feature 703).

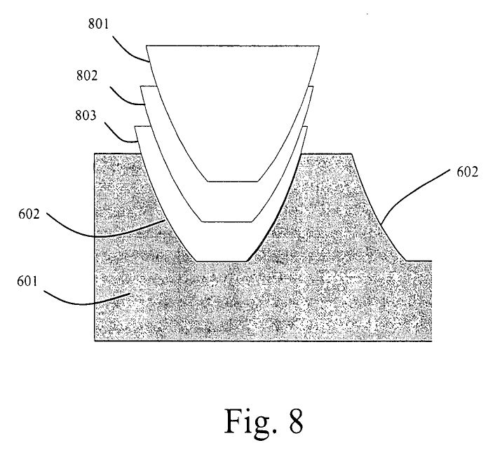

The roller cavities might be cut using single or multiple cuts to achieve the final shape on the roller 601. FIG. 8 shows a cross-sectional view of a cutter cutting a mold cavity 602 in the roller surface in three cuts. In this example, the cutter cross-section is a parabolic shape with a flat tip, resulting in mold cavities and features 104 with the same shape. During one turn of the roller 601, the cutter only plunges to the level shown in position 801 of the cutter. During later turns of the roller 601, the cutter plunges to the next two positions 802 and 803, with the final position 803 cutting the mold cavity 602 to its final shape.

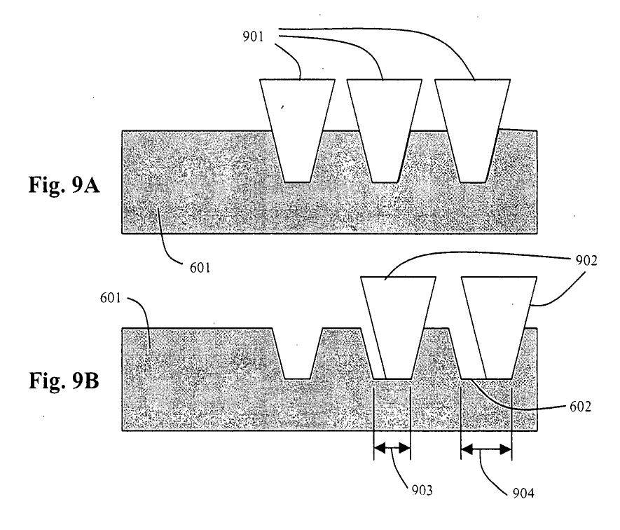

FIGS. 9A and 9B illustrate the process of cutting a roller with mold cavities 602 of varying bottom widths 903, 904, to achieve varying contact widths 302, 303 on the LEX features 104. For example, during one turn of the cylinder, the cutter might make a cut 901 one side of the cavity as shown in FIG. 9A. During later turns of the cylinder illustrated in FIG. 9B, the cutter may cut additional cuts 902 through the cavity, eventually finishing with the other side of the cavity. The cuts to fabricate the mold cavities may be made in various orders, often depending on other programming details of the fabrication machine or on which order will achieve a better surface quality.

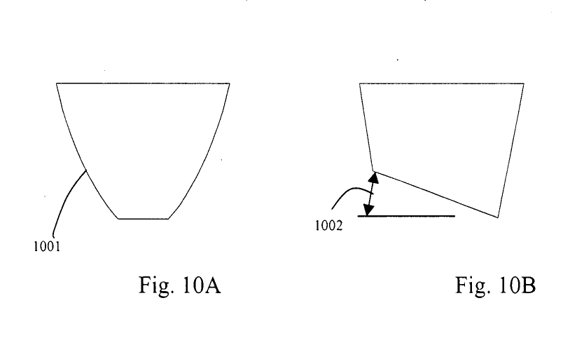

In the noted roller-cutting processes, diamond cutters are beneficial because of their ability to form an optical-quality cut surface finish and their resistance to wear, chipping, and other types of cutter damage. FIG. 10A shows a front view of the tip 1001 of a diamond cutter, and FIG. 10B shows a side view of the same cutter. The cross-section of the diamond cutter determines the cross-section of the mold cavities 602 on the roller, which in turn determines the cross-section of the features 104 on the LEX 102. As will be known to those with skill in the art, the diamond cutters must have adequate relief angles 1002 to allow the cutter to plunge into the turning roller without the roller material coming into contact with the non-cutting faces of the cutter, which would result in swaging the roller material and possible substandard cut surface quality. Typical relief angles 1002 range from approximately 7 degrees to approximately 25 degrees.

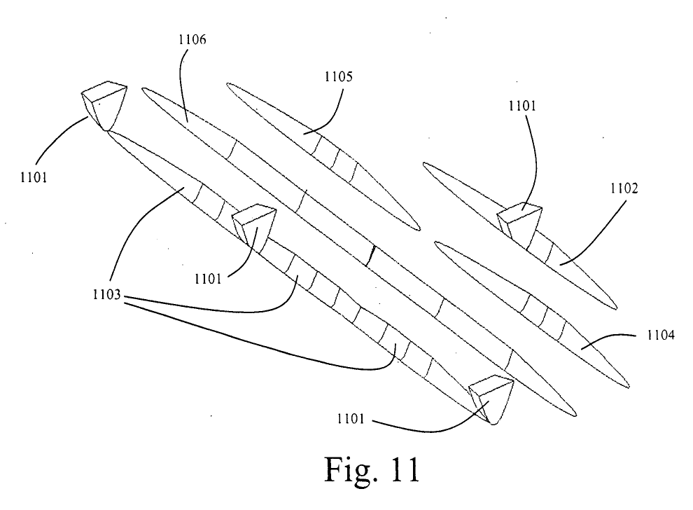

A flat mold for injection molding may be formed by a scribing process using diamond cutting tools described herein. A sleeve may also be mounted on a cylinder and engraved as described herein for fabricating a roller. Then the sleeve may be removed from the cylinder and unrolled to form the molding surface of a flat mold 601. Various replication processes known in the art, such as electroforming, may be used to copy and transform the mold 601 surface into a usable form. FIG. 11 shows a perspective view of a diamond cutter 101 cutting mold cavities 602 in the surface of a roller. In this example the cutter 1101 has a parabolic cross-section. The cutter 1101 is shown at several locations in the process of cutting cavities of various sizes. At one location the cutter is in a short cavity 1102. At another location the cutter is shown at the start, in the middle and at the end of a group of three cavities 1103 that merge together such that the cutter never emerges fully from the roller surface until the end of the third cavity. Also shown are two short cavities 1104 and 1105 that are far enough apart that the cutter may exit completely between them, and a longer cavity 1106.

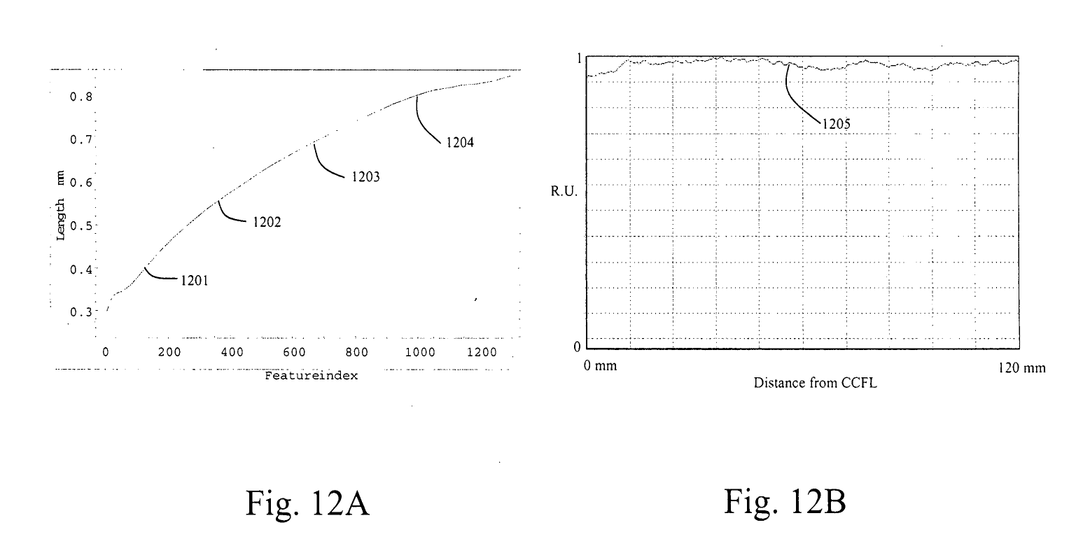

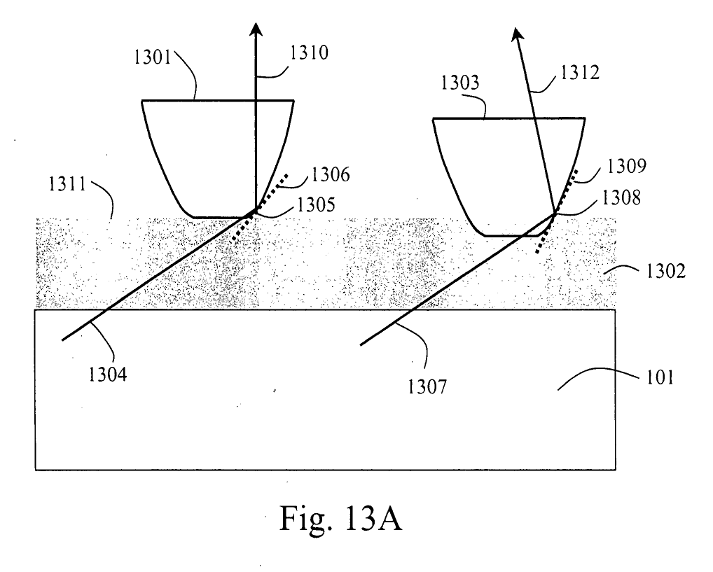

FIG. 12A is a graphical representation of the feature index (feature number in y-direction from end of LEX) versus optical contact ratio. In this example feature length in millimeters is used as a measure of optical contact ratio, but other methods discussed herein may be used as well. Curve 1202 shows the number of features versus length for a LEX in accordance with an example embodiment. At point 1201, features relatively close to an edge of the LEX near a light source have a relatively short length. Such features may be those disposed near the first portion 205 or the second portion 206 of FIG. 2. At point 1203, the features are larger than at the edge, and may be features between the edge of the LEX 102 and the central portion 204 shown in FIG. 2. At point 1204, the length of a feature is significantly larger. The features are farther from the edge of the LEX. Such features may be disposed near the central portion 204 of the LEX 102 of the embodiment of FIG. 2.

FIG. 12B is a graphical representation of the spatial luminance versus distance from a CCFL for a LEX having the length variation of features set forth in FIG. 3A. Like FIG. 12A, the distance is from an edge (first or second portion 205, 206) of the LEX 102 where a light source 103 (e.g., CCFL) is located. As can be appreciated, over the distance, the spatial luminance substantially maintains an intensity level shown in curve 1205.

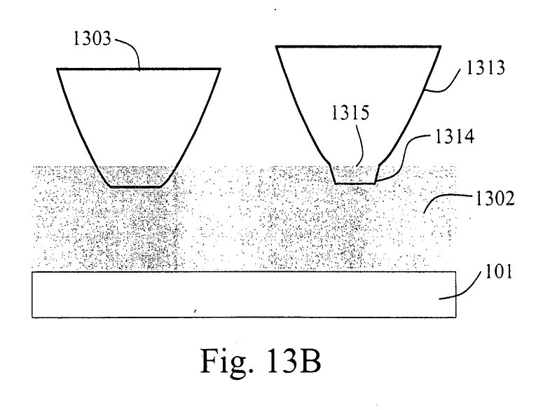

FIG. 13A is a cross-sectional view of two light extraction features of a LEX layer of an example embodiment and the trajectories of light through the features. Illustratively, these features may be two of the features 104 of the LEX 102 described previously. In the example embodiments, the light extraction features are adapted to function according to the optical principle of TIR. The features are made of a material such as referenced above. The reflective surfaces of the features are surrounded by air. Alternatively, the LEX features 104 may be surrounded by another material with an index of refraction chosen to be relatively small in order to allow TIR on the surfaces of the light guide 101 and LEX 102. The first feature 1301 is disposed over an adhesive material 1302 that is disposed over the light guide 101. The second feature 1303 is partially embedded in an adhesive material 1302, which has an index of refraction that substantially matches the indices of refraction of the light guide layer 101 and the first and second features 1301, 1303. Notably, light 1304 that is incident on the contacting portion of the feature 1301 is reflected by TIR substantially toward the viewer. As described herein, light that is reflected from the second feature 1303 has a different trajectory than light reflected from the first feature 1301 because of the partial embedding of the second feature.

As noted previously, the features of the LEX 102 function under the principle of TIR. TIR (for a structure in air) is achieved when the critical angle φ_{TIR} for incident light is exceeded as defined in equation (2) below, where nₑ is the index of refraction of the material used for the LEX 102.

$${φ}_{TIR} = {sin}^{- 1} ( \frac{1}{{n}_{e}} ) \qquad ( 2 )$$

The critical angle is measured relative to a perpendicular (normal) to the reflective surface. Light 1304 is incident at a point 1305 that has a tangent 1306 thereto. Light 1307 is incident at a more elevated point 1308 on feature 1302 that has a tangent 1309. The tangent 1306 to the first feature 1301 has a smaller slope than the tangent 1309 of the second feature. As such, the trajectory of the reflected light 1310 is at a lesser angle relative to a normal to the surface 1311 of the adhesive layer 1302. Moreover, the trajectory 1312 of the light reflected from the second feature 1302 is at a greater angle relative to the normal to the surface 1311.

As the LEX 102 is useful in redirecting light from light sources 103, there may be cases where it is useful to have a feature disposed over the adhesive layer, and in other cases it may be useful to embed the feature in the material by a selective depth to alter the trajectory by varying the point of incidence.

FIG. 13B is a cross-sectional view of features of a LEX layer of an example embodiment. As noted, the trajectory of light from a light guide may be modified by the selection of the degree of embedding of the features. In some instances it may be useful to provide the light at a trajectory that is nearly orthogonal to the LEX 102, and in other instances it may be useful to provide the light at a trajectory that is not orthogonal to the LEX 102.

The adhesive layer 1302 is often needed to provide a complete and robust assembly. The features of the LEX often are partially embedded as second feature 1303 is shown in FIG. 13B. However, this may not be useful, particularly if projection of light orthogonal to the LEX is desired. This problem is mitigated if not eliminated by the feature 1313 of the present embodiment.

Feature 1313 includes a base 1314 that is embedded in the adhesive material 1302 so that a lower surface 1315 of the feature 1313 is disposed substantially at the top surface of the adhesive layer. In this manner, the shape of the feature 1313 may be used to provide the light along a trajectory substantially perpendicular to the surface of the adhesive 1303 and thus the LEX 102. Notably, the base 1314 has a height of approximately 1.0 micrometers to approximately 5.0 micrometers and a width of approximately 10.0 micrometers to approximately 30.0 micrometers. The shape of the base 1314 may be rectangular, spherical, parabolic, triangular, a continuation of the shape of the feature sides, or other shapes. Moreover, because the base 1314 is embedded in the adhesive, which has an index of refraction that is substantially identical to the index of refraction of the base 1314, the base is optically inert. To wit, light incident on the base is neither reflected nor refracted by the base.

Beneficially, the base 1314 allows predictability in the LEX in air. To this end, without the base 1314 it is difficult to determine the depth at which the lower surface 1315 of a feature will be embedded in the adhesive. This impacts the slope of the tangent to the feature and thus the trajectory of light reflected by the feature. With the base, the lower surface may be disposed over the adhesion layer and slope of the tangent can be readily determined. Therefore, the trajectory of the reflected light is also predicted and thus consistent from feature to feature. This improves the uniformity of the light output across the surface of the LEX.

As noted previously, the features 104 of the LEX 102 may be one of a variety of shapes. The cross-sectional shape chosen for redirecting light depends on desired trajectories. These shapes include ellipses, parabolas, aspheric elements, and composites of at least two shapes. The two sides of the LEX features 104 may have different shapes. Some representative shapes are described presently.

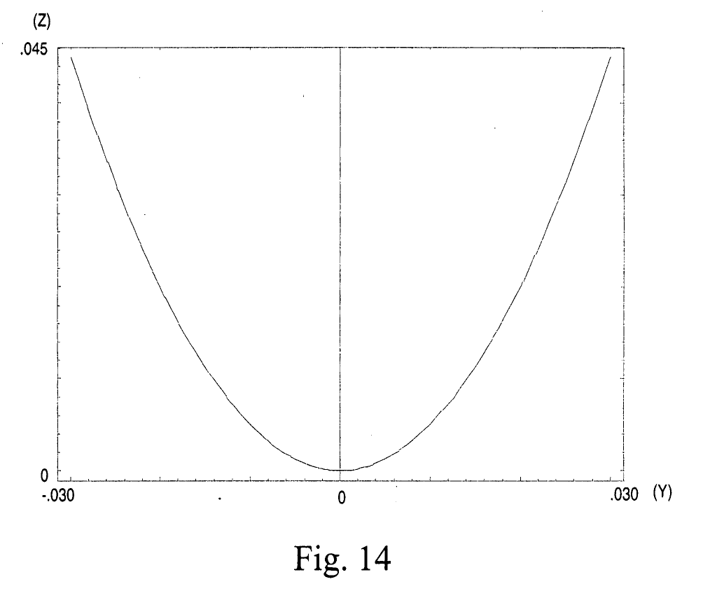

FIG. 14 is a graphical representation of a cross-section of a parabolic light extractor useful as the feature 104. The unit of scale of the width (y-axis) and height (z-axis) is millimeters. In an example embodiment, for 0<y<0.020 the parabolic feature is given by:
Z(y)=71.42857y² (3)

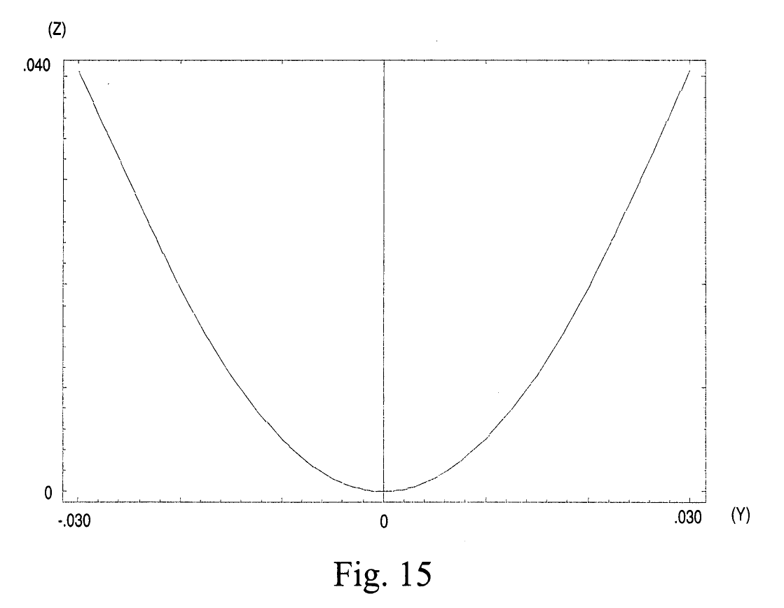

FIG. 15 is a graphical representation of a cross-section of an aspheric light extractor useful as the feature 104. The unit of scale of width (y-axis) and height (z-axis) is millimeters. In an example embodiment, for 0<y<0.020 the aspheric feature is given by:
Z(y)=78.83476y²−93751.82y⁴+2.244680E8y⁶−1.813808E11y⁸ (4)

As noted previously, the LEX 102 of the illustrative embodiments described provides improved luminance to display and light components and thus improves the image and lighting brightness. Moreover, the uniformity of the light output from the LEX 102 is also improved compared to known light redirecting layers.

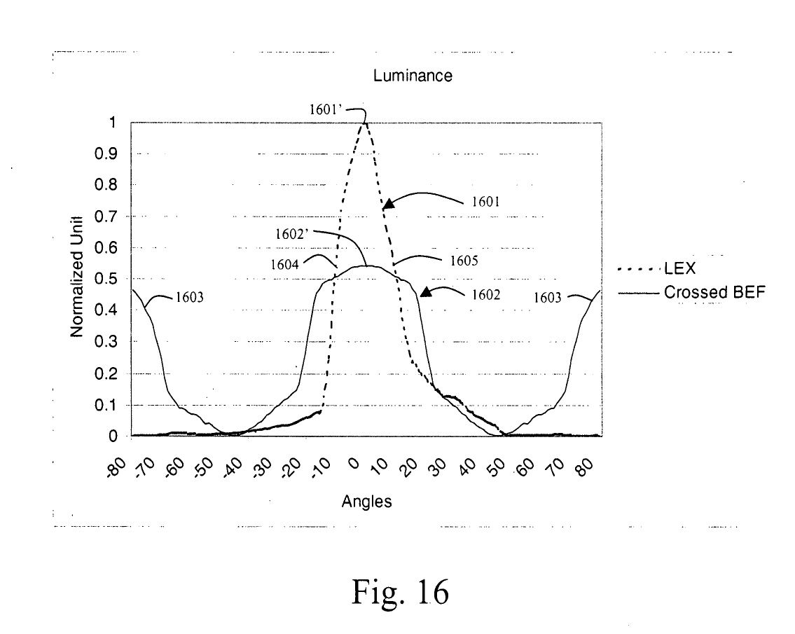

FIG. 16 is a graphical representation of light intensity versus viewing angle. Curve 1601 is the luminance (relative scale) versus vertical viewing angle (degrees) for a LEX 102 in keeping with the example embodiments. Here the vertical direction is measured in the yz-plane shown in FIG. 2. Notably, a light source (e.g., CCFL) is disposed only on one side/edge of the LEX 102 in realizing the light distribution. Curve 1602 is the luminance versus viewing angle for a known BEF.

As can be appreciated, the peak 1601′ of the luminance is significantly greater than the peak 1602′ of the luminance of the known BEF layer. Moreover, the curve 1602 includes side lobes 1603. These side lobes 1603 represent regions of brightness and thus light leakage at the extreme viewing angles.

The width of the peak luminance is often used to characterize light redirecting films. In the example embodiment, the width of the peak is between points 1604 and 1605 and has an angular breadth (Full Width Half-Maximum (FWHM)) of approximately 20.0 degrees.

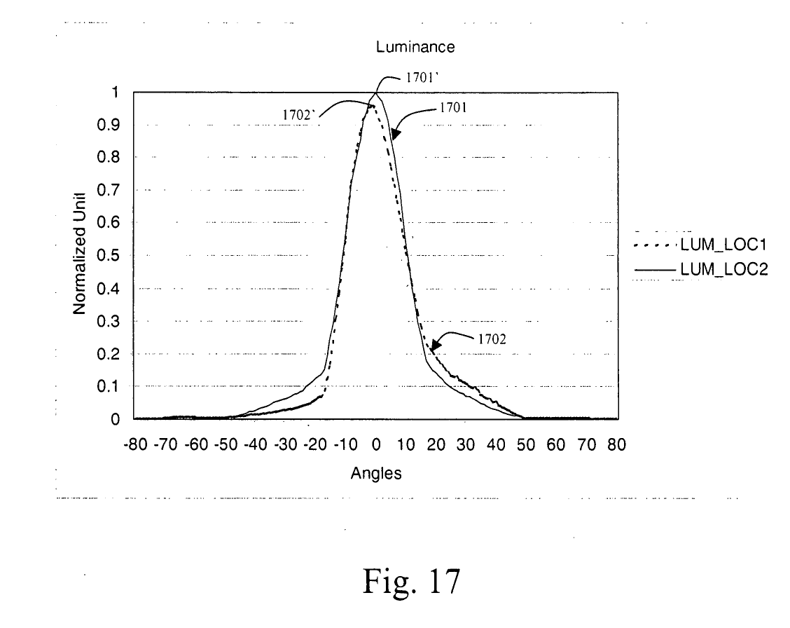

FIG. 17 is a graphical representation of light intensity versus viewing angle of a LEX in accordance with an example embodiment. Curve 1701 is the luminance (relative scale) versus viewing angle (degrees) at the center of a display for a LEX 102 in keeping with the example embodiments. Curve 1702 is the luminance for the LEX 102 at the edge of the display surface. Notably, a light source (e.g., CCFL) is disposed only on one side/edge of the LEX 102 in realizing the light distribution. As can be appreciated, the peak 1701′ of the luminance of the LEX at the center and the peak 1702′ of the luminance at the edge are substantially the same. Moreover, the distributions of light at the center and the edge of the display are substantially the same. As a result, viewing intensity is substantially the same at the edge of the display as at the center of the display across the range of possible viewing angles.

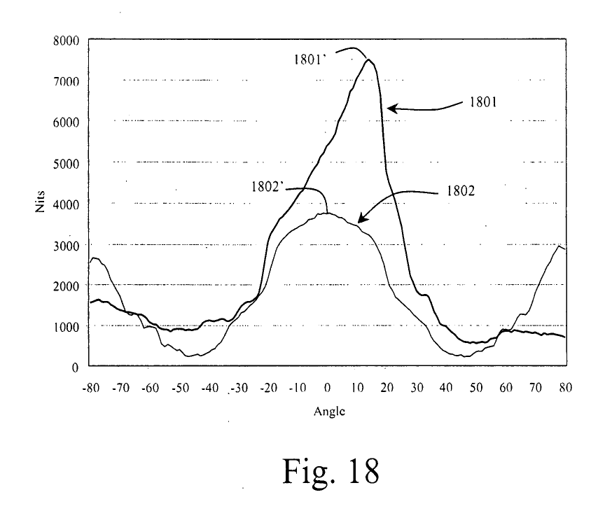

FIG. 18 is a graphical representation of luminance versus viewing angle of an example backlight device utilizing a LEX layer of an example embodiment and a comparable backlight device utilizing two crossed known BEF layers. Both backlights included a single CCFL light source 103 along one edge. Curve 1801 is the luminance of the LEX backlight measured at the center of the display. Curve 1802 is the luminance of the BEF backlight measured at the center of the display. As can be appreciated, the peak 1801′ of the luminance of the LEX backlight is significantly greater than the peak 1802′ of the luminance of the known BEF layer backlight.

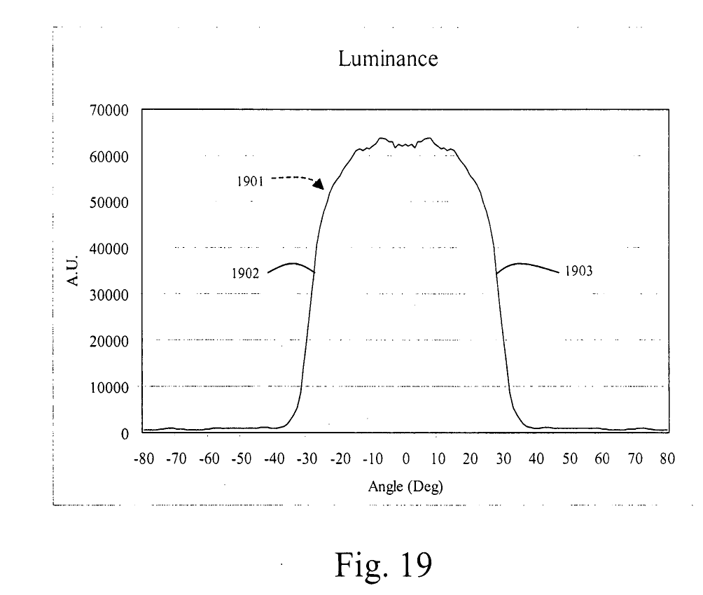

FIG. 19 is a graphical representation of luminance versus viewing angle of an example backlight device including a LEX in accordance with an example embodiment. The curve 1901 is the luminance (relative scale) versus vertical viewing angle (degrees) for a LEX 102 in keeping with the example embodiments. In this embodiment, the cross-sectional shape of the feature 104 has been designed to achieve a wider angular light distribution. In this case, for 0<y<0.020 the cross-sectional shape of the feature is a parabola given by:
Z(y)=66.67y² (5)
The viewing angle, as measured by FWHM between points 1902 and 1903, is approximately 60 degrees.

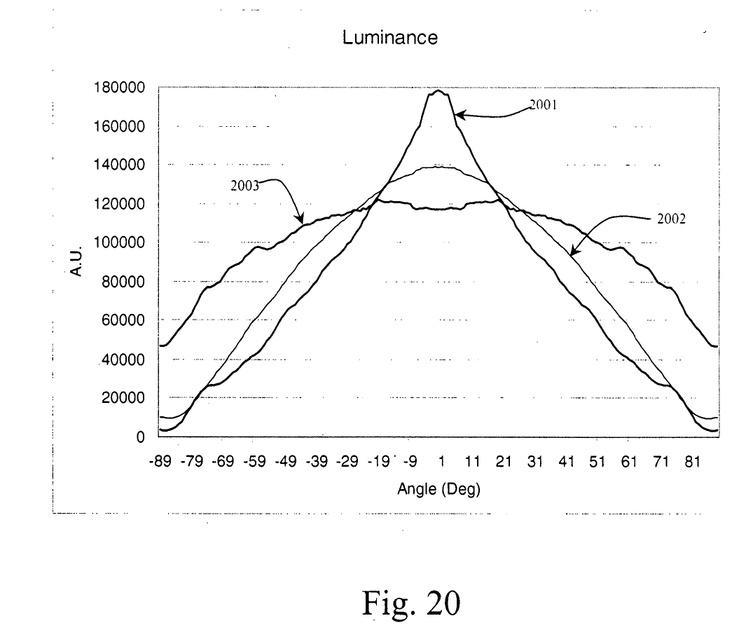

FIG. 20 is a graphical representation of luminance versus horizontal viewing angle of an example backlight device with different apex angles of bottom prismatic shape 114. Here the horizontal direction is parallel to the x-axis in FIG. 2. FIG. 20 illustrates how the horizontal viewing angle as well as the peak luminance can be adjusted by changing the apex angle of the bottom prisms. The curve 2001 is the luminance when the apex angle is 90 degrees. The corresponding FWHM horizontal viewing angle is approximately 70 degrees. The curve 2002 is the luminance when the apex angle is 150 degrees. The corresponding FWHM horizontal viewing angle is approximately 110 degrees. The curve 2003 is the luminance when there is no bottom prism 114. The corresponding FWHM horizontal viewing angle is approximately 160 degrees.

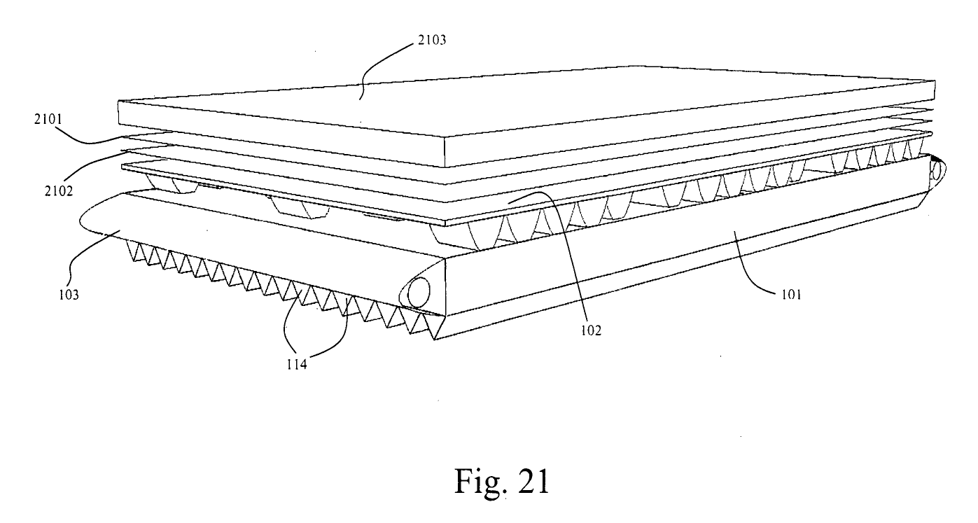

FIG. 21 is a perspective view of a display device in keeping with embodiments. The display device includes a diffuser 2101, a reflective polarizer 2102, and an image modulator 2103 disposed on top of a LEX 102 and light guide 101. Illustratively, the image modulator 2103 may be a liquid-crystal (LC) array, a digital light projector (DLP) or similar light valve useful in display applications. As the details of various elements of the display device are well within the purview of one of ordinary skill in the art, these details are omitted to avoid obscuring the present teachings.

In view of this disclosure it is noted that the various methods and devices described herein can be implemented in a variety of applications. Further, the various materials, elements and parameters are included by way of example only and not in any limiting sense. In view of this disclosure, those skilled in the art can implement the present teachings in determining their own techniques and needed equipment to effect these techniques, while remaining within the scope of the appended claims.

### PARTS LIST

101—Light Guide
102—Light Extraction Layer
103—Light Source
104—Light Extraction Features
105, 105′—Light
106—Surface
107—Light
108—Light
109—Point
110—Light
111—Light Input Surface
201—Length
202—First Pitch
203—Second Pitch
204—Central Portion
205—First End
206—Second End
207—Corners
301, 302, 303—Optical Contact Width
401—Features
402—Upper Region
403—Features
404—Lower Region
405—Features
501, 502—Feature Length
503, 504—Region
505,506—Spaces
601—Mold
602—Cavities
701,702,703—Features
801,802,803—Cutter Positions
901,902—Cuts
903, 904—Widths
1001—Tip
1002—Angles
1101—Diamond Cutter
1102, 1103, 1104, 1105, 1106—Cavities
1201—Point
1202—Curve
1203, 1204—Point
1205—Curve
1301—First Feature
1302—Adhesive Material
1303—Second Feature
1304—Light
1305—Point
1306—Tangent
1307—Light
1308—Elevated Point
1309—Tangent
1310—Reflected Light
1311—Surface
1312—Trajectory
1313—Feature
1314—Base
1315—Lower Surface
1601—Curve
1601′—Peak
1602—Curve
1602′—Peak
1603—Side Lobes
1604—Point
1605—Point
1701—Curve
1702—Curve
1701′—Peak
1702′—Peak
1801—Curve
1802—Curve
1801′—Peak
1802′—Peak
1901—Curve
1902—Point
1903—Point
2001—Curve
2002—Curve
2003—Curve
2101—Diffuser
2102—Reflective Polarizer
2103—Image Modulator

1. A light extraction layer, comprising:
a first end portion and a central portion;
a first side and a second side; and
a plurality of light extraction features disposed over the first side, wherein at least two of the light extraction features have different lengths and an optical contact ratio is greater at the central portion than at the first end portion.

2. A light extraction layer as recited in claim 1, further comprising a second end portion, wherein the optical contact ratio is greater at the central portion than at the second end portion.

3. A light extraction layer as recited in claim 1, wherein the light extraction features have a pitch and the pitch is substantially constant across the layer.

4. A light extraction layer as recited in claim 1, wherein each of the light extracting features has a contact width and the contact widths of at least two of the light extracting features are not the same.

5. A light extraction layer as recited in claim 1, wherein the length of at least another two of the light extraction features is the same.

6. A light extraction layer as recited in claim 1, wherein a length of at least one of the light extraction features disposed at the central portion is greater than a length of at least one of the light extraction features at the first end portion.

7. A light extraction layer as recited in claim 1, wherein the optical contact ratio further varies in the direction of the length of the light extraction features.

8. A light extraction layer as recited in claim 1, wherein each of the plurality of light extraction features has curved surfaces.

9. A light extraction layer as recited in claim 8, wherein the curved surfaces are substantially parabolic.

10. A light extraction layer as recited in claim 8, wherein the curved surfaces are substantially aspheric.

11. A light extraction layer as recited in claim 8, wherein the curved surfaces are substantially composite in cross-section.

12. A light extraction layer as recited in claim 1, wherein each of the light extraction features has a lower surface that includes a base portion, which is adapted to be disposed in a material and the lower surface is substantially in a plane of a surface of the material.

13. A light extraction layer as recited in claim 12, wherein the material is an adhesive.

14. A light extraction layer as recited in claim 1, further comprising a substrate that is integral with the plurality of light extraction features and each of the light extraction features reflects light in a direction that is substantially orthogonal to the substrate.

15. A light extraction layer as recited in claim 1, further comprising a substrate that is integral with the plurality of light extraction features and each of the light extraction features reflects light in a direction that is not substantially orthogonal to the substrate.

16. A light extraction layer as recited in claim 1, further comprising a substrate that is integral with the plurality of light extraction features, wherein the substrate has a thickness in the range of approximately 10.0 micrometers to approximately 1.0 mm.

17. A light extraction layer as recited in claim 1, wherein at least two of the plurality of light extraction features have a random distribution in at least one portion of the layer.

18. A display device, comprising:
a light modulator;
a light guide having a first end, a second end, a top surface, and a bottom surface;
at least one light source coupled to the first end, or the second end, or both;
a light extraction layer disposed over the top surface, wherein the light extraction layer comprises:
a first end portion, a second end portion and a central portion;
a first side and a second side; and
a plurality of light extraction features disposed over the top surface, wherein at least two of the light extraction features have different lengths and an optical contact ratio between the light extraction layer and the light guide is greater at the central portion than at the first end portion.

19. A display device as recited in claim 18, wherein the light extraction features have a pitch and the pitch is substantially constant across the layer.

20. A display device as recited in claim 19, wherein the optical contact ratio between the light extraction layer and the light guide is greater at the central portion than at the second end portion.

21. A display device as recited in claim 20, wherein each of the light extraction features has a contact width and the contact widths of at least two of the plurality of light extraction features are not the same.

22. A display device as recited in claim 21, wherein the length of at least another two of the light extraction features is the same.

23. A display device as recited in claim 18, wherein a length of at least one of the light extraction features disposed at the central portion is greater than a length of at least one of the light extraction features at the first end portion.

24. A display device as recited in claim 18, wherein the optical contact ratio further varies in the direction of the length of the light extraction features.

25. A display device as recited in claim 18, wherein each of the plurality of light extraction features has curved surfaces.

26. A display device as recited in claim 18, wherein the curved surfaces are substantially parabolic.

27. A display device as recited in claim 18, wherein the curved surfaces are substantially aspheric.

28. A display device as recited in claim 18, wherein the curved surfaces are composite in cross-sectional shape.

29. A display device as recited in claim 18, wherein each of the light extraction features has a lower surface that includes a base portion, which is adapted to be disposed in a material and the lower surface is substantially in a plane of a surface of the material.

30. A display device as recited in claim 29, wherein the material is an adhesive.

31. A display device as recited in claim 18, further comprising a substrate that is integral with the plurality of light extraction features and each of the light extraction features reflects light in a direction that is substantially orthogonal to the substrate.

32. A display device as recited in claim 18, further comprising a substrate that is integral with the plurality of light extraction features and each of the light extraction features reflects light in a direction that is not substantially orthogonal to the substrate.

33. A display device as recited in claim 18, further comprising a substrate that is integral with the plurality of light extraction features, wherein the substrate has a thickness in the range of approximately 10.0 μm to approximately 1.0 mm.

34. A display device as recited in claim 18, wherein at least two of the plurality of light extraction features have a random distribution in at least one portion of the layer.

35. A display device as recited in claim 18, wherein the light guide has a plurality of microstructures disposed over the bottom surface.

36. A display device as recited in claim 35, wherein the microstructures are substantially elongated in shape in a direction perpendicular to the first end of the light guide.

37. A display device as recited in claim 35, wherein at least one of the microstructures has a finite length that is less than the length of the light guide.

38. A display device as recited in claim 35, wherein the microstructures are disposed randomly, staggered, or overlapped.

39. A display device as recited in claim 35, wherein the microstructures are prismatic, arc, semi-circular, conic, aspherical, trapezoidal, or a composite of at least two shapes in cross-section.
